(19) United States
(12) Patent Application Publication
(10) Pub. No.: US 2013/0213751 A1
(43) Pub. Date: Aug. 22, 2013

(54) Cart Bag Safety Catch

(71) Applicant: Mark Key, North Agusta, SC (US)

(72) Inventor: Mark Key, North Agusta, SC (US)

(21) Appl. No.: 13/400,425

(22) Filed: Feb. 20, 2012

(51) Int. Cl. B62B 5/04

(52) U.S. Cl. 188/265

(57) ABSTRACT

A safety catch for a golf cart brake lever comprising: a means to attach the safety catch to a stationary object; an elastic strap, where the elastic strap includes a first end and a second end, and said means to attach extends from the first end; and a securing strap, where the securing strap includes a means to wrap the securing strap around a braking latch of a pull golf cart. In one particular embodiment, the means to attach may include a hook. In another exemplary embodiment, the means to wrap the securing strap may include hook and loop connectors at opposing ends of the securing strap.

### BACKGROUND OF THE INVENTION

1. Field of Invention

The present invention relates to a golf accessory that's utilized to secure a safety catch on a golf bag transport hand while playing a round of golf.

2. Description of Related Art

Golf is a leisure and recreational sport that is enjoyed by many individuals. Although golf is played at highly competitive levels with professionals many individuals enjoy this game on a recreational basis. The game of golf involves the striking of balls with a set of clubs over a distance in particular over a specific golf course. Golfers utilize a collection of golf clubs while playing the game of golf. Golfers transport the clubs in a golf bag that may be carried or transported by the golfer while playing over the golf course. The means of transporting the golf bag include electrical vehicle carts that have storage areas for the golfer to store their bag while seats are available for the golfers as they drive over the golf course while playing a game. Alternatively some golfers walk the golf course and therefore may utilize pull carts that are used to transport the golf clubs over the golf course.

Hand pull carts come in various sizes and varieties and typically include a braking system to secure a cart in a fixed position while the golfer addresses and hits his ball. On occasion this braking system may fail due to the failure of a safety latch that is provided on many of the pull carts that are available for golfers. Should the braking system fail many times the golf clubs may be damaged by the unexpected haphazard transport or rolling of the golf clubs. Further the clubs may easily fall out of the cart or the cart could capsize or turn over because it will be rolling without any guidance. Consequently, it would be advantageous to have a device that could be utilized to secure the braking or safety latch available on a pull cart. By being able to secure this safety latch golfers can prevent the accidental rolling of a pull cart during use thereof.

### SUMMARY OF THE INVENTION

The present invention relates to a safety catch for a golf cart brake lever comprising: a means to attach the safety catch to a stationary object; an elastic strap, where the elastic strap includes a first end and a second end, and said means to attach extends from the first end; and a securing strap, where the securing strap includes a means to wrap the securing strap around a braking latch of a pull golf cart. In one particular embodiment, the means to attach may include a hook. In another exemplary embodiment, the means to wrap the securing strap may include hook and loop connectors at opposing ends of the securing strap.

### BRIEF DESCRIPTION OF DRAWINGS

FIG. 1 depicts a cart bag safety catch in accordance with the present invention.

### DETAILED DESCRIPTION

The present invention relates to a safety catch that is utilized with a safety latch available on a conventional manual golf bag pull cart. Many pull carts that are available for golf bags include a safety latch that is activated upon the cart to place the cart in a braking or stationary position. The safety latch is usually a lever-type of latch that is held in a compressed position. Usually a clip is provided that secures the latch in a compressed position on the pull cart. Should this clip fail or become worn over a period of time the safety latch would fail and therefore the cart would roll haphazardly. Utilizing the cart safety catch in accordance with the present invention provides a means to secure the safety latch should the safety clip fail during use.

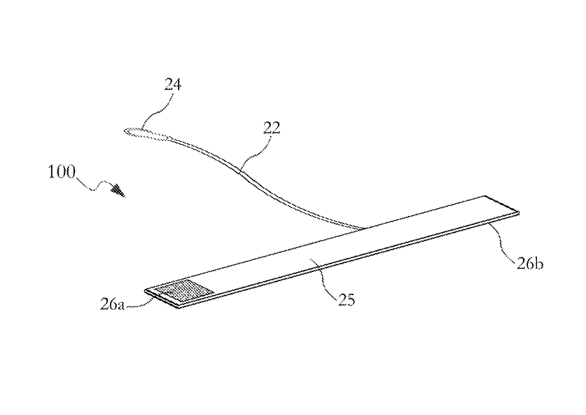

A Cart Bag Safety Catch 100 is depicted in FIG. 1. The Safety Catch 100 according to the present invention includes a Hook 24 at one end of an Elastic Strap 22. At a second end of the elastic strap is a Securing Strap 25. During use, the Hook 24 secures the catch to any available belt loop or attachment hook that may be available on the golf bag. The Elastic Strap 22 provides the means to extend the Catch 100 to an appropriate length to secure the safety catch on the pull cart. The Securing Strap 25 is provided to wrap around the safety catch provided on the bag cart to secure the golf bag. Matching Hook and Loop Connectors 26a, 26b are provided to secure the Securing Strap 25 around the safety catch provided on the golf cart. The Hook and Loop Connectors 26a, 26b are provided at opposing ends of the Securing Strap 25 and secure the Strap 25 in place. Once the securing strap is wrapped around this lever or safety catch the golfer may be assured that the catch and lever are in a secure position throughout the round of golf. This golf accessory provides an additional safety catch for the lever provided on the pull cart. This catch ensures that the golf bag remains on the cart and doesn't come off or loose when the cart is placed in a lock or a stationary position.

Use of the safety catch according to the present invention therefore provides the golfer with piece of mind while operating a standard pull cart during a round of golf. The device in addition to being able to be attached to the golf bag by the Hook 24 may also be attached to a portion of the cart itself for other security devices so that the securing strap may reach onto the safety catch. The instant invention has been shown and described in what it considers to be the most practical and preferred embodiments. It is recognized, however, that departures may be made there from within the scope of the invention and that obvious modifications will occur to a person skilled in the art.

What is claimed is:

1. A safety catch for a golf cart brake lever comprising:
a. a means to attach the safety catch to a stationary object;
b. an elastic strap, where the elastic strap includes a first end and a second end, and said means to attach extends from the first end; and
c. a securing strap, where the securing strap includes a means to wrap the securing strap around a braking latch of a pull golf cart.

2. The safety catch according to claim 1, where the means to attach includes a hook.

3. The safety catch according to claim 1, where means to wrap the securing strap includes hook and loop connectors at opposing ends of the securing strap.
